(19) United States
(12) Patent Application Publication
(10) Pub. No.: US 2013/0090977 A1
(43) Pub. Date: Apr. 11, 2013

(54) Collaboration Tool for Compliance Processing

(71) Applicants: Ying Zeng, Fremont, CA (US); Siriphat Oumtrakul, Mountain View, CA (US); Natharin Chanuntawaree, Mountain View, CA (US); Richard Choi, San Francisco, CA (US); Cheng Hu, Palo Alto, CA (US)

(72) Inventors: Ying Zeng, Fremont, CA (US); Siriphat Oumtrakul, Mountain View, CA (US); Natharin Chanuntawaree, Mountain View, CA (US); Richard Choi, San Francisco, CA (US); Cheng Hu, Palo Alto, CA (US)

(73) Assignee: SAP AG, Walldorf (DE)

(21) Appl. No.: 13/269,393

(22) Filed: Oct. 7, 2011

(51) Int. Cl. G06Q 10/06

(52) U.S. Cl. 705/7.27

(57) ABSTRACT

A computer system is described which facilitates the collaboration of participants involved in regulation/policy compliance. The system comprises two systems: a central regulation compliance system; and a collaboration forum. The central regulation compliance system is integrated with the collaboration forum to facilitate the assessment/survey process in order to attend to issues relating to actual or potential occurrences of non-compliance with regulatory/policy requirements.

### BACKGROUND

The present invention relates to compliance with government regulations and policies, and in particular to a tool to facilitate the processes involved in complying with regulations and policies.

Unless otherwise indicated herein, the approaches described in this section are not prior art to the claims in this application and are not admitted to be prior art by inclusion in this section.

Businesses around world face increasing burdens from numerous government regulations and policies. Non-compliance with government regulations and policies can cause significant financial setbacks and result damage to the business' reputation and branding. Any significant business will expend considerable effort, time, and money in order to ensure compliance with applicable government regulations and policies.

In the regulation/policy compliance process, controls are defined to check the compliance to specific regulation/policy. The effectiveness of these controls needs to be assessed to ensure the full compliance. The assessments are often performed using survey to the multiple business owners. To reach an agreement about the effectiveness of these controls, discussions between involved parties are required. These discussions occur right now without the support of a collaboration tool. The business owners who often don't log onto the central regulation compliance system can't take part in the discussion easily. Often the decisions are made by a few people without consultation with other parties. A collaboration tool integrated with the regulation compliance software can greatly facilitate the discussions, provide necessary background information to the business owners, distribute the survey questions to business owners and document the different opinions, final decision and the decision making process. This will significantly improve the assessment and survey processes and make them transparent.

### SUMMARY

In accordance with principles of the present invention, managing compliance requirements in an enterprise includes generating a compliance assessment workflow comprising a plurality of compliance-related action items relating to conformance to a plurality of compliance requirements. Information relating to the compliance assessment workflow may then be used to initiate a collaborative process to process the compliance assessment workflow. The collaborative process may include inviting a plurality of participants identified based on the compliance requirements. A conference among conferees comprising one or more of the participants is then conducted. Results of the collaborative process may then be stored.

In an embodiment, the compliance requirements are government regulations or government policies.

In embodiments, a compliance manage system may generate the compliance assessment workflow. In embodiments, the compliance assessment workflow may be generated based on data indicative of non-compliance of the compliance requirements.

In some embodiments, identification of the participants is based on one or more rules. In some embodiments, identification of the participants is determined by an expert system.

### BRIEF DESCRIPTION OF THE DRAWINGS

FIG. 1 shows compliance management in the context of an enterprise in accordance with principles of the present invention.

FIG. 2 is a high level block diagram of components of embodiments of a compliance management system in accordance with aspects of the present invention.

FIG. 3 shows processing among components of the compliance management system in accordance with principles of the present invention.

FIG. 4 depicts a computer system that may embody a compliance management system in accordance with aspects of the present invention.

### DETAILED DESCRIPTION

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

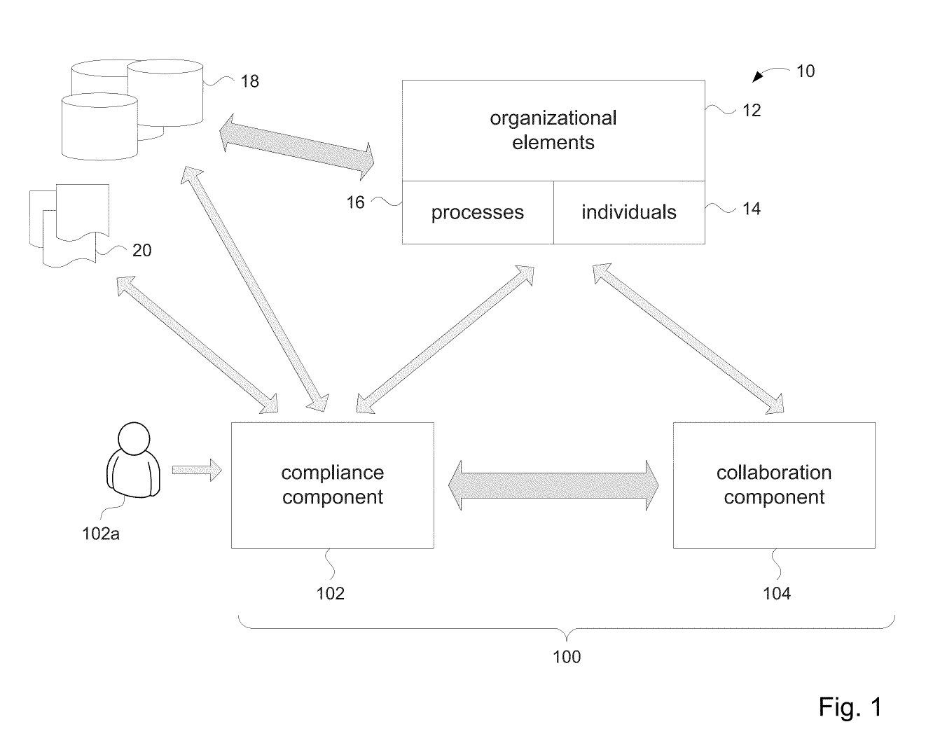

In embodiments according to principles of the present invention, a computer system is provided to facilitate the initiation and execution of collaboration efforts among individuals in an enterprise to comply with applicable regulatory and policy requirements (referred to herein generically as “compliance requirements”) imposed by a regulatory agency. The regulatory agency may be a governmental body, an industry specific body, or departments internal to the enterprise that may issue company policies, and so on. Referring to FIG. 1, an enterprise 10 is represented in terms of its organizational elements 12 (e.g., executive management, sales department, marketing group, manufacturing group, engineering, and so on) and individuals 14 in those organizational elements. Operations of the enterprise 10 proceed in accordance with numerous processes 16; for example, procurement policies, human resource policies, manufacturing guidelines, safety guidelines, and so on.

In embodiments, a compliance management system 100 includes a compliance component 102 and a collaboration component 104. The compliance component 102, also referred to as a Governance, Risk Management, and Compliance (GRC) system, represents a business enterprise's processes and policies for managing activities to ensure compliance with applicable compliance requirements. Governance refers to the policies whereby executives and management direct and control compliance activities. Risk management are the processes that collect data, identify risks, and address risk issues that may arise as a result of potential non-conformance to compliance requirements. Compliance refers to the processes to ensure conformance with the compliance requirements. An illustrative example of a compliance component 102 is GRC System™ developed and marketed by the assignee of the instant application.

The collaboration component 104 provides a platform to facilitate a collaboration effort among collaboration participants. For example, the collaboration component 104 may provide various modes of communication including audio and audio/video modes, messaging (such as instant messaging, texting and so on), document sharing, whiteboard sharing, and so on. The collaboration component 104 may employ a conference room metaphor where participants may virtually congregate; e.g., over the Internet, a virtual private network (VPN), and so on. An illustrative example of the collaboration component 104 is a StreamWork™ system, which is a platform developed and marketed by the assignee of the instant application.

In embodiments, the compliance component 102 and the collaboration component 104 may be integrated in a client-server model. For example, Representational State Transfer (REST) is an architecture style that can be used to model the interaction between the compliance component 102 and the collaboration component 104. A suitable application programming interface (API) based on the architectural principles of REST can provide WEB services on the collaboration component 104 that can be accessed by the compliance component 102.

In embodiments, the compliance component 102 may comprise computer systems that collect, as compliance data, business data 18 that is produced by the enterprise 10. For example, the business data 18 may include master data, transaction data, manufacturing data, and other data generated during the course of operating the enterprise 10. The compliance component 102 may scan the compliance data and perform various analyses to identify instances of non-conformance with applicable regulations and policies, potential instances of non-conformance, trends that may result in non-conformance, and so on. For example, criteria may be defined based on the applicable regulations and policies, and thresholds established. When the monitored data exceeds certain thresholds, that may trigger an indication of actual or potential non-compliance of applicable regulations or policies. Rules may be defined based on applicable regulations and policies, and then applied to the collected compliance data to identify actual or potential occurrences of non-compliance, and so on.

The compliance component 102 may include individuals who are responsible for managing the compliance policies. For example, a compliance manager 102a may periodically review the enterprise's processes 16 to ensure that the enterprise maintains conformance to applicable regulations and policies. The compliance manager 102a may conduct surveys with the individuals 14 in the enterprise 10. For example, compliance data gathering material 20 such as questionnaires may be distributed and responses reviewed. The compliance manager 102a may receive and review internal formal and informal reports (complaints, comments, suggestions, in-person interviews, and so on) that may be relevant to assessing conformance to applicable regulations and policies. In addition or alternatively, the compliance manager 102a may enter the compliance data that they receive into the compliance component 102 for automated assessment to identify actual or potential occurrences of non-compliance.

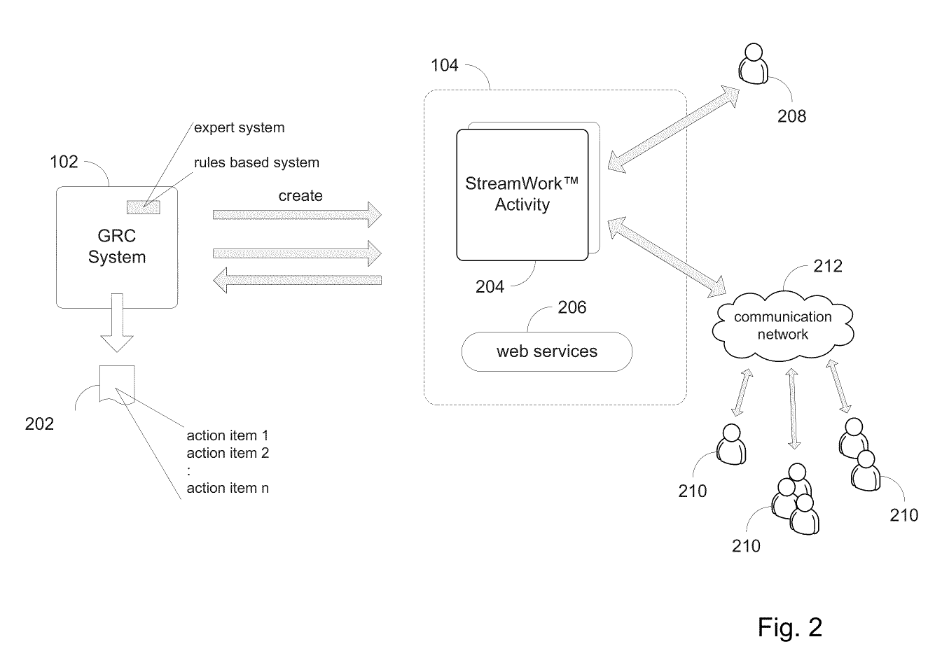

FIG. 2 shows a high level flow diagram of the compliance management system 100 in accordance with principles of the present invention. When an actual or potential occurrence of non-compliance is indicated, the compliance component 102 may generate a compliance assessment workflow 202 in response. The compliance component 102 may then trigger the collaboration component 104 to initiate a collaborative process to perform, complete or otherwise process the compliance assessment workflow 202 in order to resolve the actual or potential occurrence of non-compliance. The collaborative process includes bringing together various participants in one or more conference sessions to process the compliance assessment workflow 202. The collaborative process may be driven by the compliance component 102 via web services 206 provided in the collaboration component 104.

In a particular embodiment, where the collaboration component 104 is a StreamWork™ system, the collaborative process may be conducted as an activity 204. An activity owner 208 manages the progress of the activity 204. One or more activity participants 210 may be invited to participate in resolving issues and action items set forth in the activity 204. The collaboration component 104 may conduct the collaborative process by coordinating one or more virtual conferences where the conferees in each conference comprise a group of the participants 210. A communication network 212 allows the conferees to “virtually” attend the conference, and represents all suitable forms of communication channels including telephone lines, dedicated data lines, the Internet, and so on.

The collaborative process may result in a set of decisions, recommendations, reports and so on, collectively referred to as an “outcome” of the collaborative process. The outcome can then be conveyed back to the compliance component 102. The compliance component 102 may then take subsequent actions based on the outcome, including reporting to the compliance manager 102a, reporting to other individuals or organizations in the enterprise 10, changing parameters of processes or systems in the enterprise, and so on.

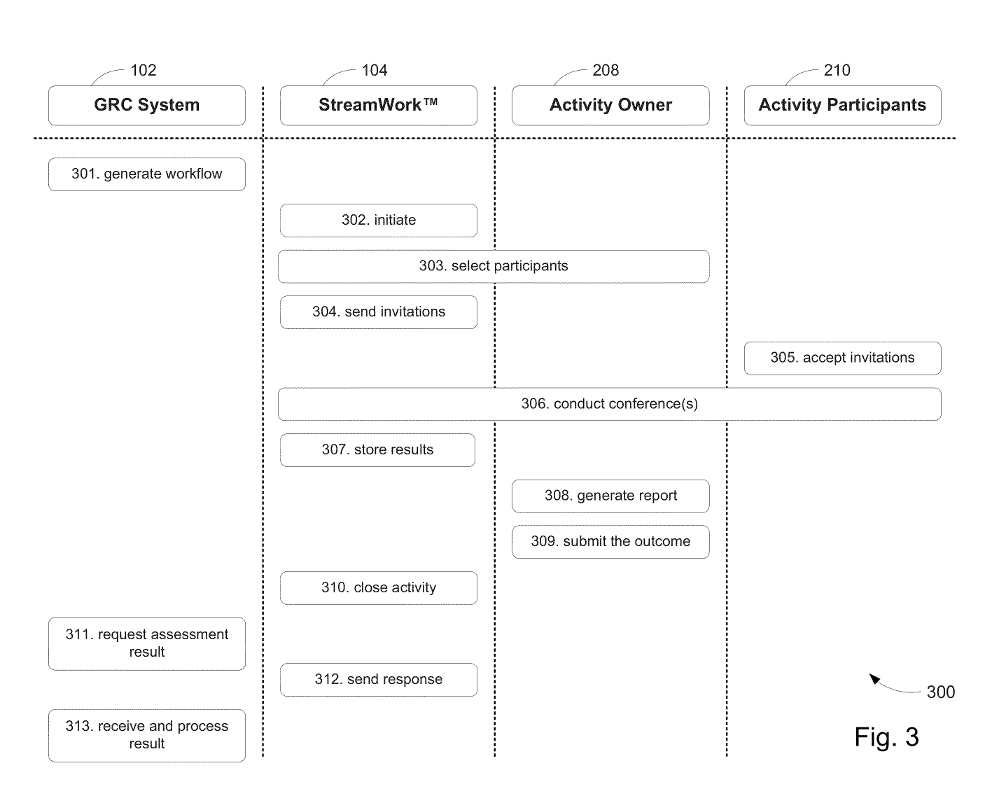

Refer now to the flow chart 300 of FIG. 3 for a more detailed description of compliance management in accordance with principles of the present invention. In order to facilitate a discussion of compliance management, the StreamWork™ collaboration system will serve as an example of the collaboration component 104. The flow chart 300 partitions the processing into separate actors who may perform the process; e.g., the compliance component 102, the collaboration component 104, activity manager 206, and participants 208.

As explained above, the compliance component 102 monitors aspects of the enterprise 10 to identify actual or potential occurrences of non-compliance with applicable regulations and policies. In a step 301, the compliance component 102 (e.g., GRC System) may that determine that corrective measures or an assessment of the actual or potential non-compliance is required. As an example, the enterprise 10 may operate a chemical processing system. Data may be collected to record the amount of waste product that is accumulated at a processing plant and the amount of waste product that is removed. A regulation may require that no more than one ton of waste product can be accumulated at a given site. The compliance component 102 may access the waste product accumulation data and the waste product removal data. If the amount of waste product removed does not maintain an accumulation level that is less than one ton, then the compliance component 102 may initiate a collaborative process to address this actual or potential occurrence of non-compliance.

Continuing with step 301, the compliance component 102 may generate a compliance assessment workflow 202. The workflow 202 may comprise a set of compliance-related action items that need to be performed to assess or otherwise address the actual or potential non-compliance. The workflow 202 may be automatically generated by the compliance component 102. For example, the compliance component 102 may include an expert system that evaluates the data that has given rise to the actual or potential non-compliance and evaluate applicable regulations and policies to develop an appropriate workflow 202 of action items. The workflow 202 may be manually generated by the compliance manager 102a. The workflow 202 may be generated by the compliance component 102 and then reviewed/modified by the compliance manager 102a, and so on. In embodiments, the compliance may be configured to selective generate the workflow 202 either automatically or manually, depending the circumstances. Consider the running example described above. The compliance assessment workflow 202 may comprise the following compliance-related action items:

1. obtain waste product accumulation data

2. provide report on changes in the chemical process

3. obtain waste removal schedule

4. provide recommendation

In a step 302, the compliance component 102 may initiate a collaborative process in the collaboration component 104 in order to perform the compliance assessment workflow specified in the compliance component 102. The collaboration component 104 may include various web services 206 that can be accessed by a suitable API such as REST in order to facilitate initiating the collaborative process. For example, the compliance component 102 may use the web services 206 to instantiate one or more discussion activities 204 in a StreamWork™ collaboration system for the compliance-related action item in the compliance assessment workflow 202. Components of the discussion activity 204 may include questions, issues for discussion, comments, and so on.

In a step 303, activity participants 210 may be selected for subsequent participation in the discussion activity(ies) 204. The web services 206 may include a service that allows the compliance component 102 to identify participants 210 for the discussion activity(ies) 204. The web services 206 may include a service that allows the compliance component 102 to associate one or more compliance-related action items from the compliance assessment workflow 202 with each participant, along with any other documents and relevant information. Participants 210 may also be selected by the activity owner 208. Participants 210 may be identified manually (e.g., by the compliance manager 102a, the activity owner 208, etc.), or automatically (e.g., by an expert system or a rule-based system in the compliance component 102). The web services 206 may include services that allow the compliance component 102 to define templates for posing inquiries and submitting surveys in a format and organization that can be processed by the collaboration component 104 and presented to the participants.

In a step 304, the collaboration component 104 may send conference invitations to the participants. The invitation may be an email message sent to a participant, or any other suitable meeting notice invitation. An invitation may include one or more the compliance-related action items or other relevant information that the recipient may need in order to prepare for the conference.

In a step 305, the collaboration component 104 may receive one or more replies, accepting or denying the conference invitations. The replies may include preparatory information from the participant; e.g., discussion outlines, notes, documentation, and so on. The collaboration component 104 may collect such information from each replier and store it in a data store. The activity owner 208 may organize the information in preparation for the conferences.

In a step 306, one or more conferences among the participants 210 may be conducted. The activity owner 208 may moderate a conference. During a conference, information gathered by the collaboration component 104 in preparation for the conference can be reviewed by the conferees. Documents may be retrieved and displayed on displays or otherwise presented to the conferees. Notes and other preparatory information provided by the participants may be retrieved and reviewed. Discussions, comments, and notes made during the conference may be recorded (step 307) for future reference. The compliance-related action items may be fully discussed and resolutions may be decided on during the conferences.

In a step 308, the activity owner 208 may review the results from each conference to arrive at conclusions reached for each of the compliance-related action items. This may include reporting that an action item has been completed, or that some decision has been made on the action item, and so on. One or more follow up discussions among the participants 210 may be needed. The activity owner 208 may generate a report on the decisions and actions taken during the collaborative process. In a step 309, the activity owner 208 may submit the report as a final outcome of the collaborative process.

In a step 310, the collaboration component 104 may close out the discussion activity(ies) 304 and notify the compliance component 102 that the collaborative process has concluded. In a step 311, the compliance component 102 may request the final outcome of the collaborative process. In an embodiment, the web services 206 may include a service that allows the compliance component 102 to make the request. The web services 206 may include services that allow the compliance component 102 to define a template to represent the information comprising the final outcome in a format and organization that can be maintained by the compliance component. In a step 312, the collaboration component 104 may transmit the final outcome to the compliance component 102. In a step 313, the compliance component 102 can then take appropriate action in accordance with the final outcome of the collaborative process.

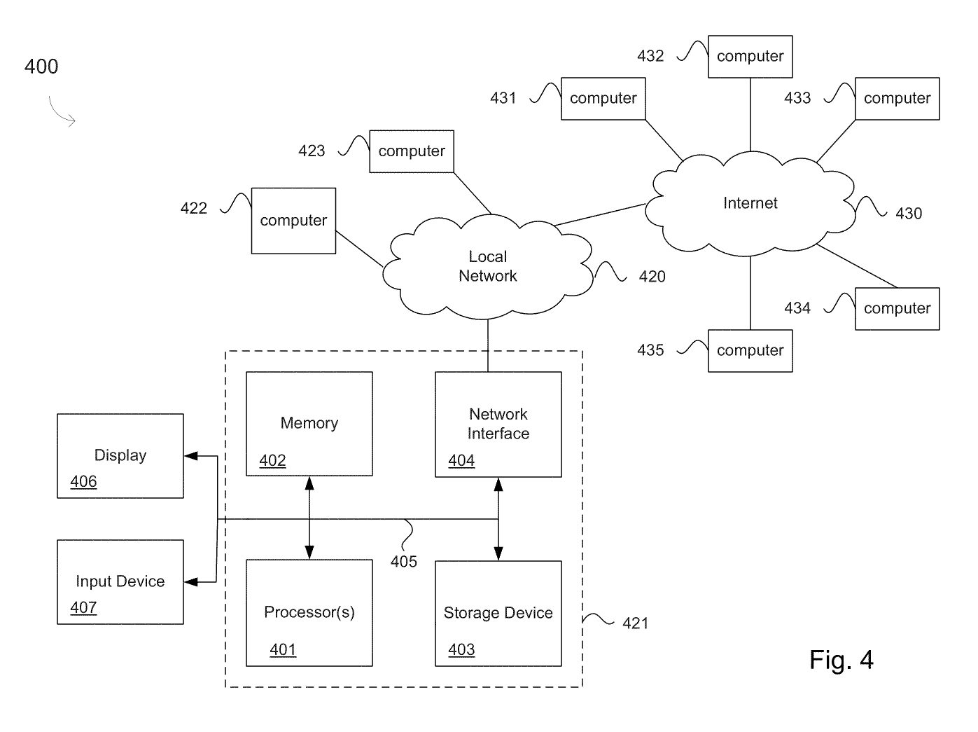

Referring to FIG. 4, in embodiments, a system 400 of computers can be configured to operate in accordance with aspects of the present invention. For example, a computer system 422 may be configured as the compliance component 102 shown in FIG. 1. Likewise, another computer system 423 may be configured as the collaboration component 104. Alternatively, the compliance component 102 and the collaboration component 104 may reside on the same computer system.

The computer system 421 illustrates typical components, including a data processor subsystem 401 which may comprise one or more data processing units. A memory subsystem 402 may comprise random access memory (usually volatile memory such as DRAM) and non-volatile memory such as FLASH memory, ROM, and so on. A storage subsystem 403 may comprise one or more mass storage devices such as hard disk drives and the like. The storage subsystem 403 may include remote storage systems; e.g., for data mirroring, remote backup and such. A network interface subsystem 404 can provide users (e.g., applications 112, FIG. 1) with access to the computer system 400, for example over a telecommunication network. A system of buses 405 can interconnect the foregoing subsystems, providing control lines, data lines, and/or voltage supply lines to/from the various subsystems. The computer system 421 may be connected to a suitable display(s) 412 and input devices 411 such as a keyboard and a mouse input device.

The memory subsystem 402 may have stored in the non-volatile memory computer executable programs, which when executed can cause the data processing subsystem 401 to operate as a compliance component 102 and/or a collaboration component 104 in accordance with principles of the present invention.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method for managing compliance requirements comprising operating a system of computers to perform steps of:
a first computer system generating a compliance assessment workflow comprising a plurality of compliance-related action items relating to conformance to a plurality of compliance requirements;
the first computer system transmitting information relating to the compliance assessment workflow to a second computer system to initiate a collaborative process in the second computer system to process the compliance assessment workflow;
the second computer system, responsive to the first computer system, conducting the collaborative process, including:
transmitting messages to a plurality of participants who are identified based on the compliance requirements, each message including one or more of the compliance-related action items; and
coordinating a conference among conferees comprising one or more of the participants, the coordinating including:
receiving from one or more of the conferees responses to the compliance-related action items; and
presenting to the conferees the responses to the compliance-related action items for further consideration by the conferees, thereby enabling collaboration among the conferees to decide on a resolution for each of the compliance-related action items;
the second computer system storing results of the collaborative process when resolutions of the compliance-related action items have been decided; and
the second computer system communicating to the first computer system an indication that the collaborative process has completed.

2. The method of claim 1 wherein the compliance requirements are government regulations or government policies.

3. The method of claim 1 further comprising the first computer receiving an instruction from a user to generate the compliance assessment workflow.

4. The method of claim 1 further comprising the first computer receiving data indicative of non-compliance of the compliance requirements and the first computer assessing the data, wherein generating the compliance assessment workflow is based on an outcome of assessing the data.

5. The method of claim 1 wherein identification of the one or more participants is further based on one or more rules.

6. The method of claim 1 wherein identification of the one or more participants is further based on an expert system.

7. The method of claim 1 further comprising the second computer system receiving information about additional participants, wherein the conferees further comprise one or more of the additional participants.

8. A compliance management system comprising:
a first computer system; and
a second computer system,
the first computer system configured to:
generate a compliance assessment workflow comprising a plurality of compliance-related action items relating to conformance to a plurality of compliance requirements; and
transmit information relating to the compliance assessment workflow to a second computer system to initiate a collaborative process in the second computer system to process the compliance assessment workflow;
the second computer system configured to:
transmit messages to a plurality of participants who are identified based on the compliance requirements, each message including one or more of the compliance-related action items; and
coordinate a conference among conferees comprising one or more of the participants, the coordinating including:
receive from one or more of the conferees responses to the compliance-related action items; and
present to the conferees the responses to the compliance-related action items for further consideration by the conferees, thereby enabling collaboration among the conferees to decide on a resolution for each of the compliance-related action items;
store results of the collaborative process when resolutions of the compliance-related action items have been decided; and
communicate to the first computer system an indication that the collaborative process has completed.

9. The system of claim 8 wherein the second computer system is further configured to provide services that are accessed by the first computer system to receive the information relating to the compliance assessment workflow.

10. The system of claim 8 wherein the compliance requirements are government regulations or government policies.

11. The system of claim 8 wherein the first computer system is further configured to receive an instruction from a user to generate the compliance assessment workflow.

12. The system of claim 8 wherein the first computer is further configured to receive data indicative of non-compliance of the compliance requirements, wherein the compliance assessment workflow is generated based on an outcome of assessing the data.

13. The system of claim 8 wherein identification of the one or more participants is further based on one or more rules.

14. The system of claim 8 wherein identification of the one or more participants is further based on an expert system.

15. A compliance management system comprising:
a first computer including means for generating a compliance assessment workflow comprising a plurality of compliance-related action items relating to conformance to a plurality of compliance requirements;
the first computer including means for transmitting information relating to the compliance assessment workflow to a second computer system to initiate a collaborative process in the second computer system to process the compliance assessment workflow;
the second computer including means, responsive to the first computer system, for conducting the collaborative process, including:
means for transmitting messages to a plurality of participants who are identified based on the compliance requirements, each message including one or more of the compliance-related action items; and
means for coordinating a conference among conferees comprising one or more of the participants, including:
means for receiving from one or more of the conferees responses to the compliance-related action items; and
means for presenting to the conferees the responses to the compliance-related action items for further consideration by the conferees, thereby enabling collaboration among the conferees to decide on a resolution for each of the compliance-related action items;
the second computer further including means for storing results of the collaborative process when resolutions of the compliance-related action items have been decided; and
the second computer further including means for communicating to the first computer system an indication that the collaborative process has completed.

16. The system of claim 15 wherein the compliance requirements are government regulations or government policies.

17. The system of claim 15 wherein the first computer further includes means for receiving an instruction from a user to generate the compliance assessment workflow.

18. The system of claim 15 wherein the first computer further includes means for receiving data indicative of non-compliance of the compliance requirements and the first computer assessing the data, wherein generating the compliance assessment workflow is based on an outcome of assessing the data.

19. The system of claim 15 wherein identification of the one or more participants is further based on one or more rules.

20. The system of claim 15 wherein identification of the one or more participants is further based on an expert system.
